(19) United States
(12) Patent Application Publication
(10) Pub. No.: US 2016/0150119 A1
(43) Pub. Date: May 26, 2016

(54) DYNAMIC IMAGE CAPTURE SYSTEM

(71) Applicant: TRANS ELECTRIC CO., LTD., Changhua (TW)

(72) Inventors: Pao-Shun HUANG, Changhua (TW); Kang-Yuan LIU, Changhua (TW)

(21) Appl. No.: 14/673,977

(22) Filed: Mar. 31, 2015

(30) Foreign Application Priority Data
Nov. 25, 2014 (TW) 103140787

(51) Int. Cl. H04N 1/21; H04N 5/235

(52) U.S. Cl. CPC H04N 1/2112; H04N 5/2355

(57) ABSTRACT

A dynamic image capture system includes an image capture device including a storage module, an image capture module for capturing a series of images at a predetermined image capture rate, and a control unit. The control unit includes a processing module for receiving the images from the image capture module, and is operable in one of a standard state, where the processing module stores all the images received from the image capture module in the storage module, and a selective-saving state, where the processing module selects a subgroup of the images from all the images received thereby at an image selection rate of 1/K, where K is an integer not less than one, and stores the subgroup of the images selected thereby in the storage module.

### CROSS-REFERENCE TO RELATED APPLICATION

This application claims priority of Taiwanese Application No. 103140787, filed on Nov. 25, 2014, the contents of which are hereby incorporated by reference.

### FIELD

The disclosure relates to an image capture system, more particularly to a dynamic image capture system capable of selectively storing images captured thereby.

### BACKGROUND

An image capture system, for example, a digital video camera or a smart phone, can be operated in a video recording mode, where it captures a series of images of an object or a scene at an image capture rate of, for example, 30 frames/sec, and then stores the captured images in a storage module, such as a memory card, installed therein. In this case, if the image capture system is operated in the video recording mode for a long period of time, there will be many images to be stored in the storage module. Therefore, the storage module may be required to provide a relatively large memory storage space for long-period video recording.

### SUMMARY

Therefore, an object of the present disclosure is to provide a dynamic image capture system that can selectively store images captured thereby.

According to the present disclosure, there is provided a dynamic image capture system. The dynamic image capture system of this disclosure includes an image capture device that includes a storage module, an image capture module and a control unit.

The image capture module captures a series of images at a predetermined image capture rate.

The control unit includes a processing module electrically connected to the image capture module for receiving the images captured thereby, and further electrically connected to the storage module. The processing module is operable in one of a standard state, where the processing module stores all the images from the image capture module in the storage module, and a selective-saving state, where the processing module selects a subgroup of the images from the images received thereby at an image selection rate of 1/K, where K is an integer not less than one, so as to store the subgroup of the images selected thereby in the storage module.

### BRIEF DESCRIPTION OF THE DRAWINGS

Other features and advantages of the present disclosure will become apparent in the following detailed description of the embodiments with reference to the accompanying drawings, of which:

FIG. 1 is a schematic block diagram illustrating the first embodiment of a dynamic image capture system according to the present disclosure;

FIG. 2 exemplarily illustrates relationships between images captured in the first embodiment and images stored in the first embodiment;

FIG. 3 is a schematic block diagram illustrating the second embodiment of a dynamic image capture system according to the present disclosure;

FIG. 4 is a schematic block diagram illustrating the third embodiment of a dynamic image capture system according to the present disclosure; and

FIG. 5 is a schematic block diagram illustrating the fourth embodiment of a dynamic image capture system according to the present disclosure.

### DETAILED DESCRIPTION

Before the present disclosure is described in greater detail with reference to the accompanying embodiments, it should be noted herein that like elements are denoted by the same reference numerals throughout the disclosure.

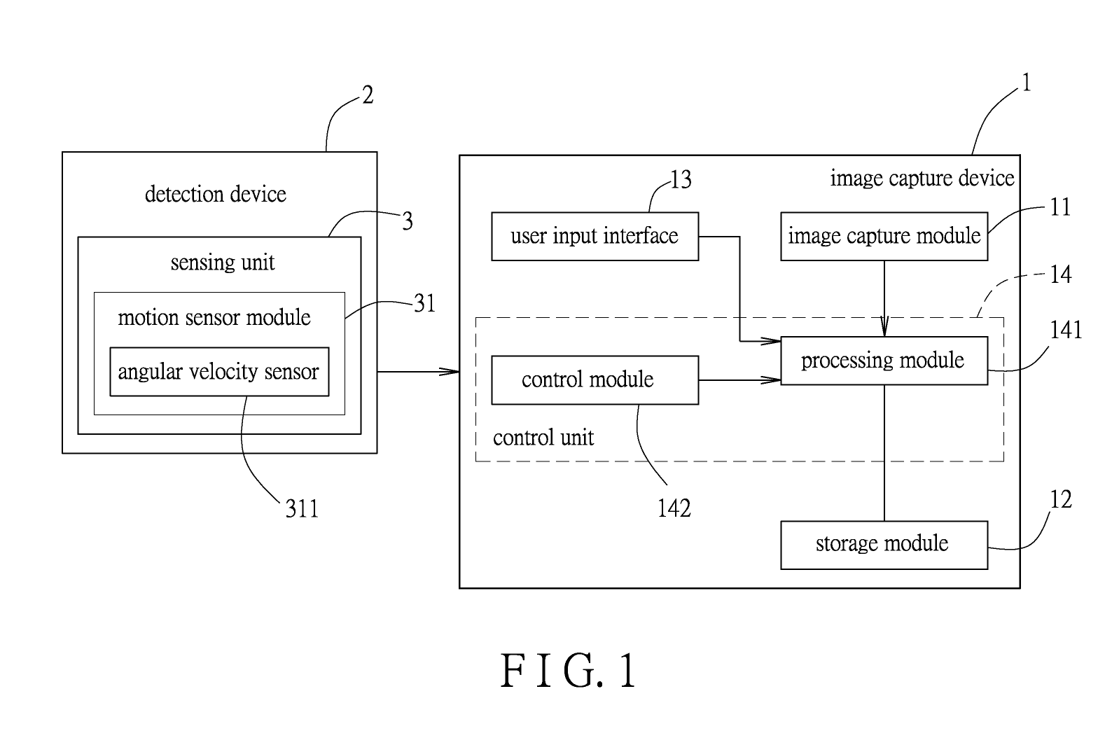

Referring to FIG. 1, the first embodiment of a dynamic image capture system according to this disclosure is shown to include an image capture device 1, and a detection device 2 connected wiredly to the image capture device 1. The dynamic image capture system may be implemented in, but is not limited to, a digital video camera, a smart phone or an event data recorder. However, in other embodiments, the image capture device 1 and the detection device 2 may be spaced apart from each other, and may be connected wirelessly to each other using one of WiFi, Bluetooth and Zigbee techniques.

The image capture device 1 includes a storage module 12, an image capture module 11, a user input interface 13, and a control unit 14 including a processing module 141 that is connected electrically to the image capture module 11, the user input interface 13 and the storage module 12. The image capture module 11 captures a series of images at a predetermined image capture rate, for example, sixty images per second, and outputs the images captured thereby to the processing module 141 of the control unit 14.

The processing module 141 is operable in one of a standard state, where the processing module 141 stores all the images received from the image capture module 11 in the storage module 12, and a selective-saving state, where the processing module 141 selects a subgroup of the images from all the images received thereby at an image selection rate of 1/K, where K is an integer not less than one, and stores the subgroup of the images selected thereby in the storage module 12.

The user input interface 13 is manually operable to control the processing module 141 to switch between the standard state and the selective-saving state. Specifically, the user input interface 13 is manually operable to generate and output a first control signal to the processing module 141 when it is desirable to switch the processing module 141 into the standard state.

The detection device 2 of this embodiment is capable of detecting motion of the dynamic image capture system so as to generate a detecting signal, and outputs the detecting signal to the image capture device 1. In this embodiment, the control unit 14 of the image capture device 1 further includes a control module 142 that is electrically connected to the detection device 2 for receiving the detecting signal therefrom, and that is further electrically connected to the processing module 141 for controlling the processing module 141 to operate in the standard state upon determining that a predetermined condition is met with reference to the detecting signal.

In this embodiment, for example, the detection device 2 includes a sensing unit 3 that includes, but is not limited to, a motion sensor module 31 for sensing motion thereof that is representative of the motion of the dynamic image capture system so as to generate the detecting signal. The detecting signal is represented by, for example, a sensing index (e.g., a sensing value) that is associated with the motion thus sensed. The control module 142 determines that the predetermined condition is met when the sensing value representing the detecting signal is greater than a predetermined threshold value.

In this embodiment, the motion sensor module 31 includes, but is not limited to, an angular velocity sensor 311 for sensing an angular velocity. In this case, the detecting signal is represented by a sensing value of the angular velocity sensed by the angular velocity sensor 311.

Specifically, when the predetermined condition is met, the control module 142 generates and outputs a second control signal to the processing module 141. Thus, the processing module 141 switches from the selective-saving state to the standard state in response to receipt of any one of the first control signal from the user input interface 13 and the second control signal from the control module 142.

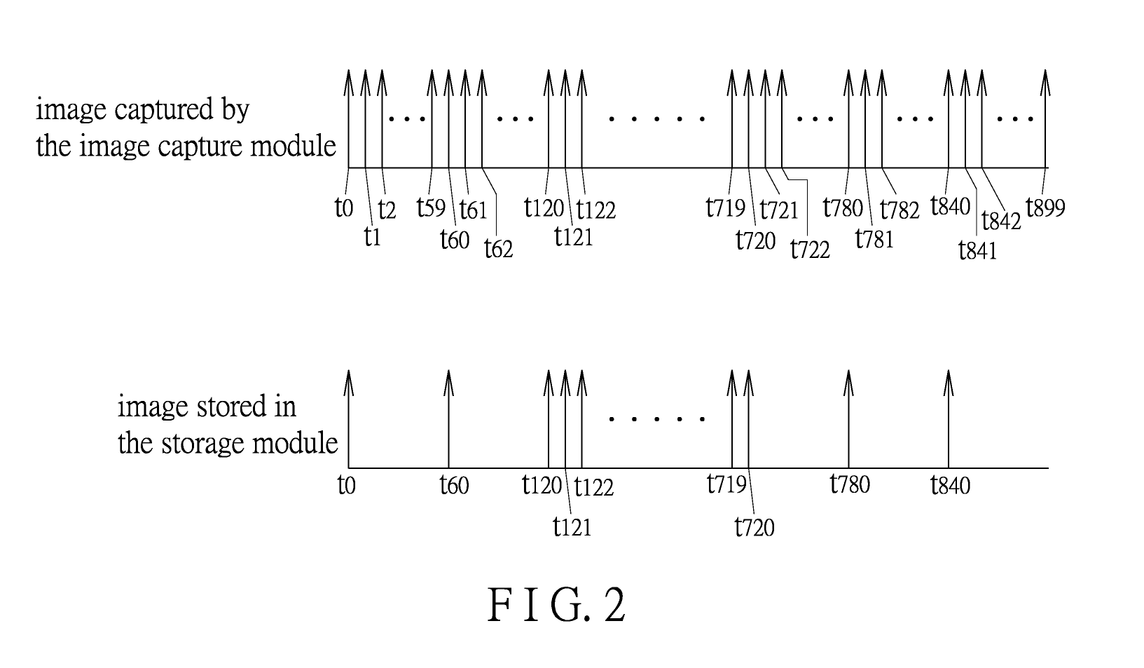

As one example, the dynamic capture system of this embodiment may be installed on a bicycle such that the dynamic capture system moves along with the bicycle. Therefore, motion of the bicycle is representative of the motion of the dynamic image capture system, and is detected by the motion sensor module 31 of the detection device 2. In this example, it is assumed that K=60, and the predetermined threshold corresponding to the angular velocity is 120 dps. Referring to FIGS. 1 and 2, the images captured by the image capture module 11 at the image capture rate of 60 images/second are generated respectively at times t0˜t899, as shown in the upper plot of FIG. 2. It is assumed that during a time period from the time t0 to the time t119, the sensing value of angular velocity of the bicycle as sensed by the angular velocity sensor 311 is about 80 degrees per second (dps). In this case, since the sensing value, i.e., 80 dps, is not greater than the predetermined threshold, i.e., 120 dps, the second control signal is not generated by the control module 142. Assuming that the first control signal is not generated by the user input interface 13 during this period, the processing module operates in the selective-saving state. As a result, with K=60, a subgroup of the images generated respectively at, for example, the times t0 and t60, as shown in the lower plot of FIG. 2, is selected by the processing module 141 and is stored in the storage module 12. It is assumed that thereafter, in a proceeding time period from the time t120 to the time t719, the sensing value of the angular velocity of the bicycle as sensed by the angular velocity sensor 311 is about 160 dps. In this case, since the sensing value of 160 dps is greater than the predetermined threshold of 120 dps, the second control signal is generated by the control module 142 and is outputted to the processing module 141. Therefore, the processing module 141 switches from the selective-saving state to the standard state in response to receipt of the second control signal. As a result, the images captured respectively at the times t120˜t719, as shown in the lower plot of FIG. 2, are stored in the storage module 12. Finally, during a time period from the time t720 to the time t899, with the assumption that the sensing value of the angular velocity of the bicycle as sensed by the angular velocity sensor 311 is not greater than 120 dps, and that the first control signal is not generated, the processing module 141 switches from the standard state back to the selective-saving state. As a result, a subgroup of the images generated respectively at, for example, the times t720, t780 and t840, as shown in the lower plot of FIG. 2, is stored in the storage module 12.

In such a configuration, the image capture system of this disclosure can selectively store the images captured by the image capture module 11 based on the motion thereof, thereby effectively saving the memory storage space in the storage module 12.

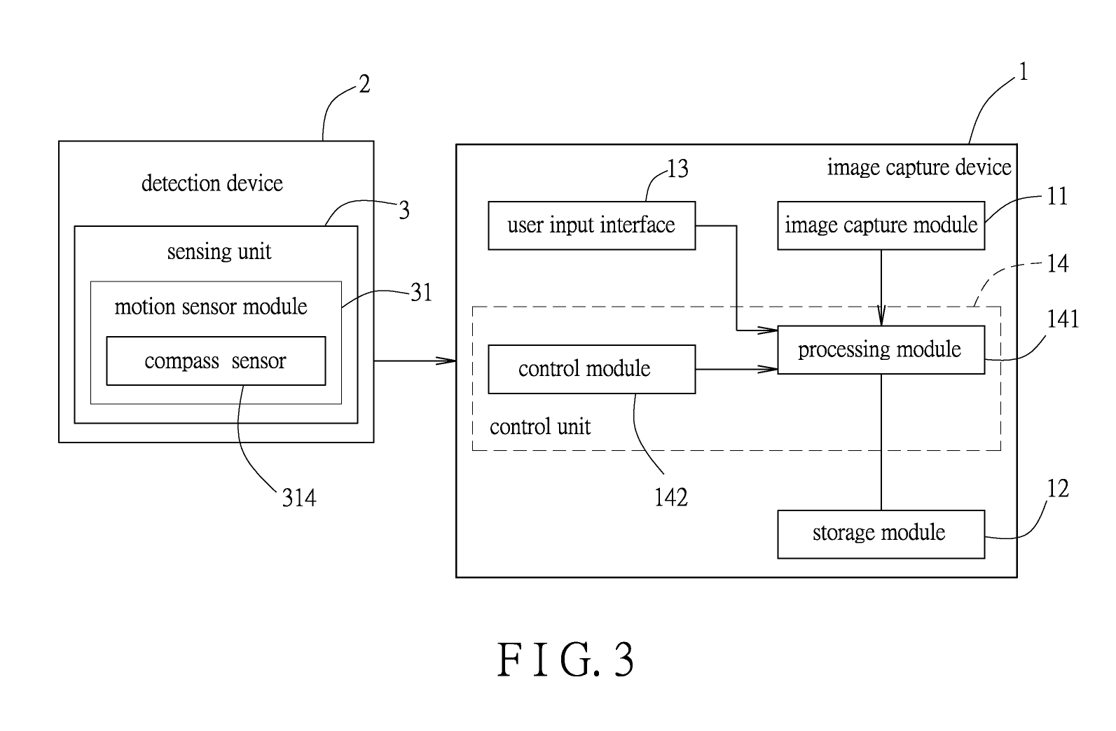

FIG. 3 illustrates the second embodiment of a dynamic image capture system according to this disclosure, which is a modification of the first embodiment and differs from the first embodiment in that the control module 142 determines that the predetermined condition is met when the sensing value representing the detecting signal is associated with specific geographic cardinal direction (s).

In addition, the motion sensor module 31 includes, but is not limited to, a compass sensor 314 for sensing a geographic cardinal direction to generate a sensing index. Specifically, the control module 142 determines that the predetermined condition is met when the geographic cardinal direction with which the sensing index corresponds to the specific geographic cardinal direction(s).

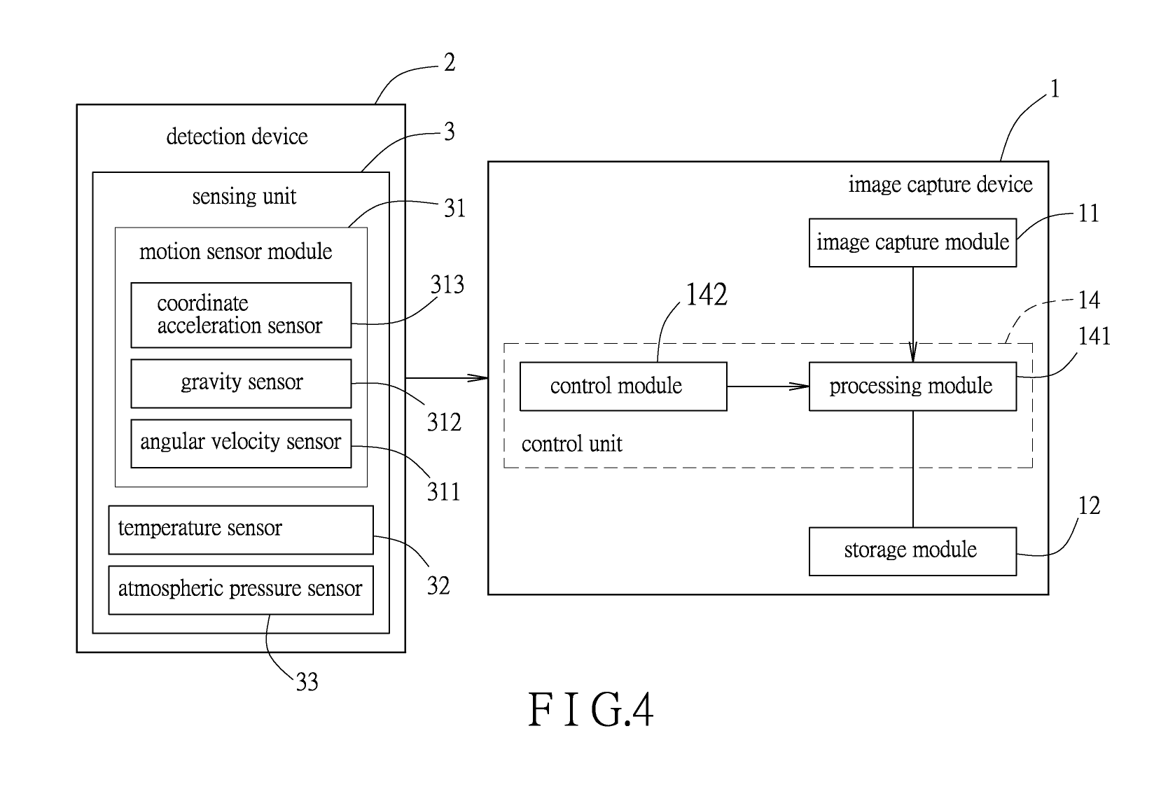

FIG. 4 illustrates the third embodiment of a dynamic image capture system according to this disclosure, which is a modification of the first embodiment and differs from the first embodiment in that the user input interface 13 of FIG. 1 is omitted. Therefore, the processing module 141 switches from the selective-saving state to the standard state in response to receipt of only the second control signal.

In this embodiment, the motion sensor module 31 of the sensing unit 3 of the detection device 2 further includes, in addition to the angular velocity sensor 311, a coordinate acceleration sensor 313 for sensing a coordinate acceleration so as to generate a sensing value that is associated with the coordinate acceleration thus sensed, and a gravity sensor 312 for sensing a proper acceleration so as to generate a sensing value that is associated with the proper acceleration thus sensed.

In addition, the detection device 2 is further capable of detecting a parameter associated with an environment in which the dynamic image capture system is situated, so that the detecting signal generated thereby is further representative of the parameter thus detected. In this embodiment, the sensing unit 3 of the detection device 2 further includes a temperature sensor 32 and an atmospheric pressure sensor 33, in addition to the motion sensor module 31. The temperature sensor 32 senses a temperature associated with the environment so as to generate a sensing value that is associated with the temperature thus sensed. The atmospheric pressure sensor 33 senses an air pressure associated with the environment so as to generate a sensing value that is associated with the air pressure thus sensed.

Therefore, the detecting signal of this embodiment is represented by the sensing value of the angular velocity sensed by the angular velocity sensor 311, the sensing value of the coordinate acceleration sensed by the coordinate acceleration sensor 313, the sensing value of the proper acceleration sensed by the gravity sensor 312, the sensing value of the temperature sensed by the temperature sensor 32 and the sensing value of the air pressure sensed by the air pressure sensor 33.

In this embodiment, the control module 142 determines that the predetermined condition is met when any one of the sensing values represented by the detecting signal is greater than a respective predetermined threshold so as to output the second control signal to the processing module 141.

For example, once the control module 142 detects that the sensing value associated with the temperature is greater than the respective predetermined threshold, the second control signal generated by the control module 142 is outputted to the processing module 141. As a result, the processing module 141 switches from the selective-saving state to the standard state in response to receipt of the second control signal.

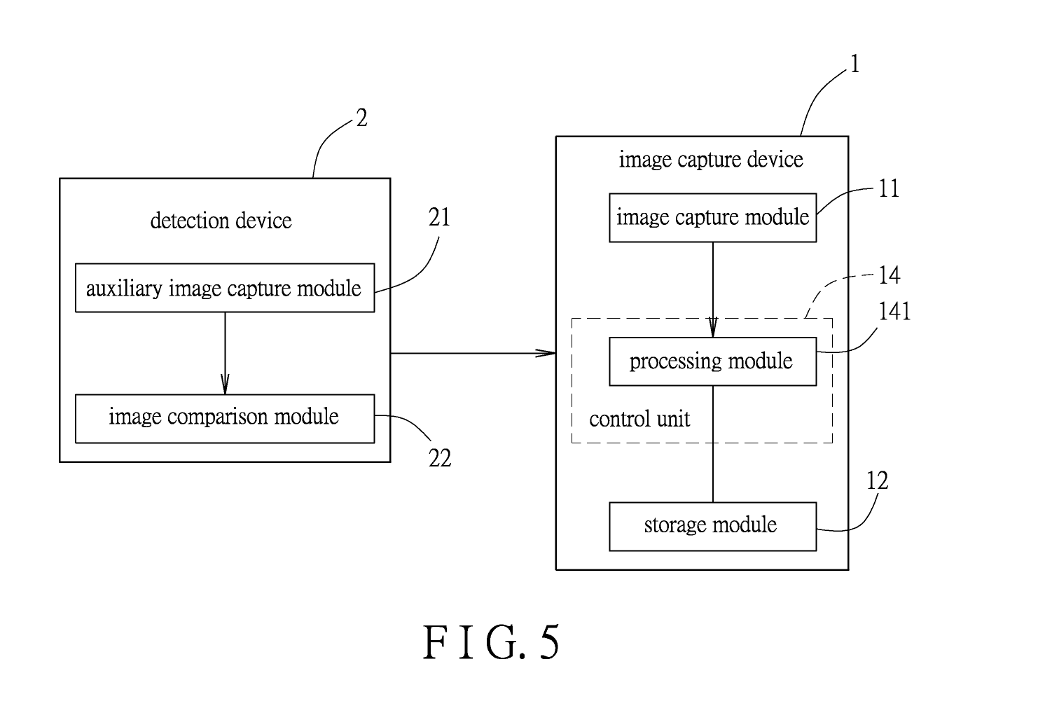

FIG. 5 illustrates the fourth embodiment of a dynamic image capture system according to this disclosure, which is a modification of the first embodiment. Unlike the first embodiment, the user input interface 13 and the control module 142 of the first embodiment of FIG. 1 are omitted in this embodiment.

In addition, unlike the previous embodiments, the detection device 2 is capable of detecting change associated with an environment in which the dynamic image capture system is situated so as to generate a detecting signal signifying the change. The processing module 141 of the control unit 14 of the image capture device 1 is in communication with the detection device for receiving the detecting signal therefrom, and is controlled to operate in the standard state upon receipt of the detecting signal. In other words, the detecting signal in this embodiment serves as a kind of control signal. Specifically, in this embodiment, the detection device 2 includes an auxiliary image capture module 21 and an image comparison module 22 coupled to the auxiliary image capture module 21.

The auxiliary image capture module 21 captures a series of detection images associated with the environment, and outputs the detection images captured thereby to the image comparison module 22.

The image comparison module 22 receives the detection images from the auxiliary image capture module 21. The image comparison module 22 is operable to compare each adjacent pair of the detection images and generate a control signal upon determining that a difference between two adjacent ones of the detection images is greater than a threshold condition. An example of the threshold condition is that there exists a difference between two adjacent ones of the detection images.

To sum up, the present disclosure saves memory storage space of the storage module 12 by monitoring what happens in the surroundings of the dynamic image capture system, be it changes in the environment, or specific parameters associated with the environment, through a variety of sensing means or determination schemes, such that when the surroundings of the dynamic image capture system are considered to be minimally varying, the dynamic image capture system operates in the selective-saving state to save fewer images, and only operates in the standard state to save all images when the surroundings are considered to involve more significant changes or when a preset condition is satisfied. The embodiments of this disclosure entail the use of the first control signal from the input interface 13 (FIG. 1), the second control signal from control module 142 (FIGS. 1 and 4) or the detecting signal from the detection device 2 (FIG. 5) to control operation of the processing module 141 of the control unit 14 of the image capture device 1 of the image capture system. Specifically, during operation of the selective-saving state, the processing module 141 selectively stores the images captured by the image capture module 11 based on the image selection rate of 1/K such that the memory storage space in the storage module 12 can be saved.

While the present disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A dynamic image capture system comprising:
an image capture device including
a storage module,
an image capture module for capturing a series of images at a predetermined image capture rate, and
a control unit including a processing module electrically connected to said image capture module for receiving the images captured thereby and further electrically connected to said storage module, said processing module being operable in one of a standard state, where said processing module stores all the images received from said image capture module in said storage module, and a selective-saving state, where said processing module selects a subgroup of the images from all the images received thereby at an image selection rate of 1/K, where K is an integer not less than one, and stores the subgroup of the images selected thereby in said storage module.

2. The dynamic image capture system as claimed in claim 1, wherein said image capture device further includes a user input interface that is coupled to said processing module and that is operable to control said processing module to switch between the selective-saving state and the standard state.

3. The dynamic image capture system as claimed in claim 1, further comprising a detection device for detecting motion of said dynamic image capture system so as to generate a detecting signal, said control unit of said image capture device further including a control module that is electrically connected to said detection device for receiving the detecting signal therefrom, and that is further electrically connected to said processing module for controlling said processing module to operate in the standard state upon determining that a predetermined condition is met with reference to the detecting signal.

4. The dynamic image capture system as claimed in claim 3, wherein:
said detection device includes a motion sensor module for sensing motion thereof that is representative of the motion of said dynamic image capture system, so as to generate the detecting signal, the detecting signal being represented by a sensing value that is associated with the motion thus sensed, said control module determining that the predetermined condition is met when the sensing value representing the detecting signal is greater than a predetermined threshold value.

5. The dynamic image capture system as claimed in claim 4, wherein said motion sensor module of said detection device includes at least one of a coordinate acceleration sensor, a gravity sensor and an angular velocity sensor, such that the detecting signal is represented by at least one of a sensing value of a coordinate acceleration sensed by said coordinate acceleration sensor, a sensing value of a proper acceleration sensed by said gravity sensor and a sensing value of an angular velocity sensed by said angular velocity sensor, said control module determining that the predetermined condition is met when anyone of the sensing values is greater than a respective predetermined threshold value.

6. The dynamic image capture system as claimed in claim 3, wherein:
said detection device includes a motion sensor module for sensing motion thereof that is representative of the motion of said dynamic image capture system, so as to generate the detecting signal, the detecting signal being represented by a sensing index that is associated with the motion thus sensed, said control module determining that the predetermined condition is met when the sensing index representing the detecting signal is associated with specific geographic cardinal direction(s).

7. The dynamic image capture system as claimed in claim 6, wherein said motion sensor module of said detection device includes a compass sensor, such that the detecting signal is represented by a sensing index of a geographic cardinal direction sensed by said compass sensor, said control module determining that the predetermined condition is met when the sensing index corresponds to the specific geographic cardinal direction(s).

8. The dynamic image capture system as claimed in claim 1, further comprising a detection device for detecting a parameter associated with an environment in which said dynamic image capture system is situated so as to generate a detecting signal, said control unit of said image capture device further including a control module that is electrically connected to said detection device for receiving the detecting signal therefrom, and that is further electrically connected to said processing module for controlling said processing module to operate in the standard state upon determining that a predetermined condition is met with reference to the detecting signal.

9. The dynamic image capture system as claimed in claim 8, wherein said detection device includes a temperature sensor for sensing a temperature associated with the environment so as to generate the detecting signal, the detecting signal being represented by a sensing value that is associated with the temperature thus sensed, said control module determining that the predetermined condition is met when the sensing value represented by the detecting signal is greater than a predetermined threshold value.

10. The dynamic image capture system as claimed in claim 8, wherein said detection device includes an atmospheric pressure sensor for sensing an air pressure associated with the environment so as to generate the detecting signal, the detecting signal being represented by a sensing value that is associated with the air pressure thus sensed, said control module determining that the predetermined condition is met when the sensing value represented by the detecting signal is greater than a predetermined threshold value.

11. The dynamic image capture system as claimed in claim 8, wherein said detection device includes an atmospheric pressure sensor for sensing an air pressure associated with the environment and a temperature sensor for sensing a temperature associated with the environment, so as to generate the detecting signal, the detecting signal being represented by a sensing value that is associated with the temperature thus sensed and a sensing value that is associated with the air pressure thus sensed, said control module determining that the predetermined condition is met when any one of the sensing values represented by the detecting signal is greater than a respective predetermined threshold value.

12. The dynamic image capture system as claimed in claim 8, wherein said detection device is connected wiredly to said image capture device.

13. The dynamic image capture system as claimed in claim 8, wherein said detection device is connected wirelessly to said image capture device using one of WiFi, Bluetooth and Zigbee techniques.

14. The dynamic image capture system as claimed in claim 1, further comprising a detection device for detecting change associated with an environment in which said dynamic image capture system is situated so as to generate a detecting signal signifying the change, said processing module of said control unit of said image capture device being in communication with said detection device for receiving the detecting signal therefrom, and being controlled to operate in the standard state upon receipt of the detecting signal.

15. The dynamic image capture system as claimed in claim 14, wherein said detection device includes:
an auxiliary image capture module for capturing a series of detection images associated with the environment; and
an image comparison module coupled to said auxiliary image capturing module for receiving the detection images captured thereby, said image comparison module being operable to generate the detecting signal upon determining that a difference between two adjacent ones of the detection images is greater than a threshold condition.

16. The dynamic image capture system as claimed in claim 14, wherein said detection device is connected wiredly to said image capture device.

17. The dynamic image capture system as claimed in claim 14, wherein said detection device is connected wirelessly to said image capture device using one of WiFi, Bluetooth and Zigbee techniques.
